(19) United States
(12) Patent Application Publication
(10) Pub. No.: US 2006/0113220 A1
(43) Pub. Date: Jun. 1, 2006

(54) Upflow or downflow separator or shaker with piezoelectric or electromagnetic vibrator

(76) Inventors: Eric Scott, Conroe, TX (US); George E. Smith, Missouri, TX (US); George Alexander Burnett, Aberdeen (GB); Kevin McDonough, The Woodlands, TX (US); Kenneth Wayne Seyffert, Houston, TX (US); Guy L. McClung III, Spring, TX (US)

Correspondence Address: Guy McClung, PMB 347, 16690 Champion Forest Drive, Spring, TX, 77379-7023, US

(21) Appl. No.: 11/280,977

(22) Filed: Nov. 16, 2005

Related U.S. Application Data
(63) Continuation-in-part of application No. 11/255,159, filed on Oct. 20, 2005.
(63) Continuation-in-part of application No. 11/096,192, filed on Mar. 31, 2005.
Application No. 11/096,192 is a continuation-in-part of application No. 10/949,882, filed on Sep. 25, 2004.
(63) Continuation-in-part of application No. 10/835,256, filed on Apr. 29, 2004.
(63) Continuation-in-part of application No. 10/512,372, filed on Oct. 25, 2004.
(63) Continuation-in-part of application No. 10/373,216, filed on Feb. 24, 2003, now Pat. No. 6,907,375.
(60) Provisional application No. 60/424,262, filed on Nov. 6, 2002.

(51) Int. Cl. B07B 13/16

(52) U.S. Cl. 209/250; 209/19

(57) ABSTRACT

A vibratory separator (in one aspect for treating drilling material) and methods of use, the separator in certain aspects having a base, a basket or box movably mounted on the base, screen apparatus on the basket or box, the material flowing to the screen apparatus for treatment (downflow or upflow), at least a portion of the screen apparatus not inclined downhill (e.g. said portion or all horizontal or uphill), electromagnetic or piezoelectric vibratory apparatus connected to the basket or to the screen apparatus for vibrating the basket and the screen apparatus or for vibrating the screen apparatus, driving apparatus for driving the vibratory apparatus, and control apparatus (on-site and/or remote) for controlling the driving apparatus and the vibratory apparatus.

### RELATED APPLICATIONS

This is: a continuation-in-part of U.S. application Ser. No. 11/255,159 filed 20 Oct. 2005 and a continuation-in-part of U.S. application Ser. No. 11/096,192 filed Mar. 31, 2005 which is a continuation-in-part of U.S. application Ser. No. 10/949,882 filed Sep. 25, 2004; a continuation-in-part of U.S. application Ser. No. 10/835,256 filed Apr. 29, 2004; a continuation-in-part of U.S. Ser. No. 10/512,372 filed Oct. 25, 2004 which claims priority from U.S. Ser. No. 10/134,027 filed Apr. 26, 2002 and Application Ser. No. PCT/IB03/01031 filed Mar. 12, 2003; and a continuation-in-part of U.S. Ser. No. 10/373,216 filed Feb. 24, 2003 which claims priority from U.S. Application Ser. No. 60/424,262 filed Nov. 6, 2002—all of which are incorporated fully herein and with respect to all of which the present invention claims priority under the Patent Laws.

### BACKGROUND OF THE INVENTION

1. Field Of The Invention

This invention is directed to vibratory separators and shale shakers; to such separators and shakers which, in certain aspects use electromagnetic and/or piezoelectric vibratory apparatuses; which have either an upflow or downflow for material to be treated; and to methods of their use.

2. Description of Related Art

Vibratory separators are used for processing a variety of materials and, in certain systems assist in reclaiming drilling fluid and/or in maintaining certain desired properties of drilling fluid by using vibrating screens to remove certain particles. Undesirable particles may include drilling cuttings and debris picked up in the drilling process. Smaller desirable particles may include drilling fluid additives that are required for maintaining desired drilling fluid density and viscosity. The flow of material to be treated by these screens is either onto the screens from above (“downflow”) or up to the screens from below (“upflow”).

### SUMMARY OF THE PRESENT INVENTION

The present invention, in at least certain aspects, discloses a shale shaker or a vibratory separator with a base, a basket or a box movably mounted on the base and for supporting screen apparatus for treating material introduced to the vibratory separator, screen apparatus supported by the basket or box, the material flowing to the screen apparatus for treatment (downflow onto the screen apparatus or upflow to the screen apparatus), at least a portion of the screen apparatus not inclined downhill, electromagnetic or piezoelectric vibratory apparatus connected to the basket or box for vibrating the basket or box and the screen apparatus or to the screen apparatus for vibrating the screen apparatus, driving apparatus for driving the vibratory apparatus, and control apparatus for controlling the driving apparatus and the vibratory apparatus.

The present invention, in certain embodiments, discloses a shale shaker or vibratory separator with a base; a basket or box or other screen mounting structure movably mounted on the base for supporting screen apparatus for treating material introduced to the basket or box; a screen, screens, screen assembly, or screen assemblies (“screen etc.”) on the basket or box, either with an upflow flow path of material to be treated or with flow of material from above; and at least one electromagnetic or piezoelectric vibratory apparatus for vibrating the basket or other structure to vibrate the screen, or with direct connection the screen etc. for vibrating the screen etc.

The present invention, in certain aspects, discloses an upflow vibratory separator or shale shaker with: a box or basket; a primary screen assembly in the box or basket; a container, the box or basket and the primary screen assembly in the container; vibratory apparatus for vibrating the primary screen assembly or for vibrating the primary screen assembly and the box or basket; at least part of the container disposed beneath the primary screen assembly; and the vibratory apparatus having electromagnetic or piezoelectric vibratory apparatus and/or with driving apparatus for the vibratory apparatus and control apparatus for controlling the vibratory apparatus and the driving apparatus. In one aspect, such a separator or shaker has a deflector adjacent a material input for directing material flowing through the material input away from the primary screen assembly.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide new, unique, useful, and nonobvious systems and methods of their use—all of which are not anticipated by, rendered obvious by, suggested by, or even implied by any of the prior art, either alone or in any possible legal combination; and it is, therefore, an object of at least certain preferred embodiments of the present invention to provide:

New, useful, unique, efficient, non-obvious vibratory separators and shale shakers and methods of their use and such separators and shakers, in at least some aspects, with electromagnetic or piezoelectric vibratory apparatus for vibrating a screen, screens, screen assembly, or screen assemblies in the separator or shaker; and, in one aspect, such a separator or shaker in which flow of material to be treated is “upflow.”

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1 is schematic side cross-section view of a system according to the present invention.

FIG. 2A is a schematic side cross-section view of a system according to the present invention.

FIG. 2B is a cross-section view of part of the system of FIG. 2A.

FIG. 2C an end view of the system of FIG. 2A.

FIG. 3 is a schematic side cross-section view of a system according to the present invention.

FIG. 4A is a schematic side cross-section view of a system according to the present invention.

FIG. 4B is an end view of the system of FIG. 4A.

FIG. 4C is a cross-section view of the system of FIG. 4A.

FIG. 5A is a schematic side cross-section view of a system according to the present invention.

FIG. 5B is an end view of the system of FIG. 5A.

FIG. 6 is a top schematic view of a system according to the present invention.

FIG. 7A is a perspective view of a shale shaker according to the present invention.

FIG. 7B is an end view of the shaker of FIG. 7A.

FIG. 7C is a side view of the shaker of FIG. 7A.

FIG. 7D is a top view of the shaker of FIG. 7A.

FIG. 7E is a side view of part of the shaker of FIG. 7A.

FIG. 8A is a side view in cross-section of a shaker according to the present invention.

FIG. 8B is a side view in cross-section of a shaker according to the present invention.

FIG. 8C is a side view in cross-section of a shaker according to the present invention.

### DESCRIPTION OF EMBODIMENTS PREFERRED AT THE TIME OF FILING FOR THIS PATENT

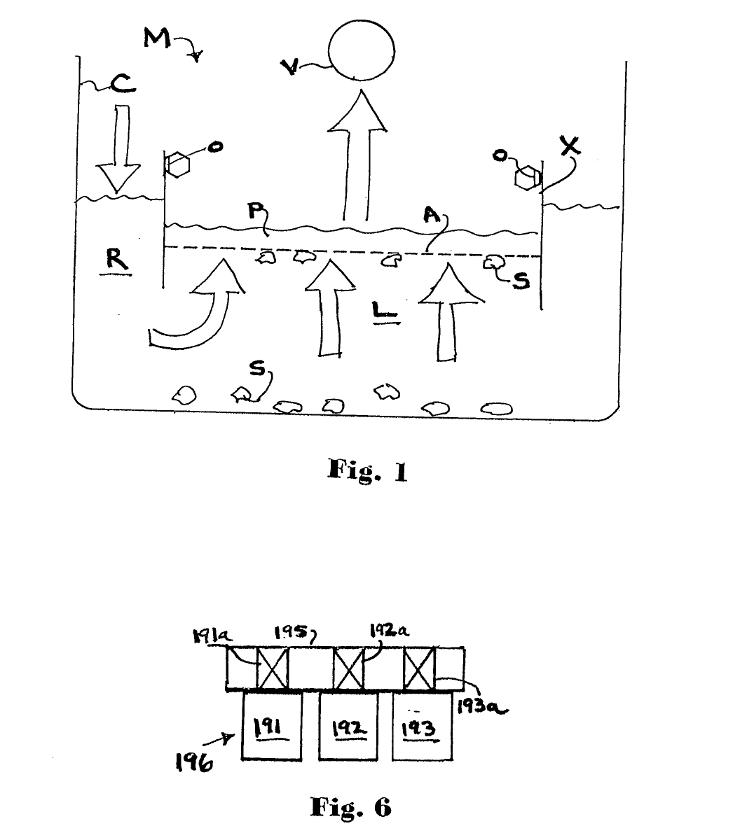

FIG. 1 shows a system M according to the present invention which has a container C into which material R is introduced, e.g. the material including liquid L and solids S. The material R flows to a screen apparatus A which is mounted in a basket or box X. Part P of the material, e.g. liquid or liquid plus some solids, flows up through the screen apparatus A. The part P is removed from the system by removal apparatus V (e.g. vacuum or pump apparatus). Part of the material, e.g. solids S and agglomerations or masses of solids, either settles down in the container C without contacting the screen apparatus A or, upon being prevented from further upward flow by the screen apparatus A and/or by material already adjacent the screen apparatus A, falls downwardly in the container C.

Electromagnetic vibrator apparatus B vibrates the basket X and, thus, the screen apparatus A. It is within the scope of the present invention to use one, two, three, four or more electromagnetic vibrator apparatuses (and to do so for any vibrator or vibration apparatus of any embodiment disclosed herein). It is within the scope of the present invention for the screen apparatus A (and the apparatus 110 described below) to be any suitable known screen or screen assembly used for vibratory separators or shale shakers. In one particular aspect the material R is drilling material with drilling fluid and drilled solids. Instead of, or in addition to, one or more electromagnetic vibrator apparatuses, according to the present invention, (as is true for any embodiment according to the present invention) one, two, three, four or more piezoelectric vibration apparatuses are used. Also, according to the present invention any vibrator or vibration apparatus of any embodiment according to the present invention may be connected directly to the screen apparatus instead of to the basket X. Appropriate mounts and/or isolators and/or shock absorbers O may be used to mount the vibrator or vibration apparatuses to a basket or directly to a screen apparatus.

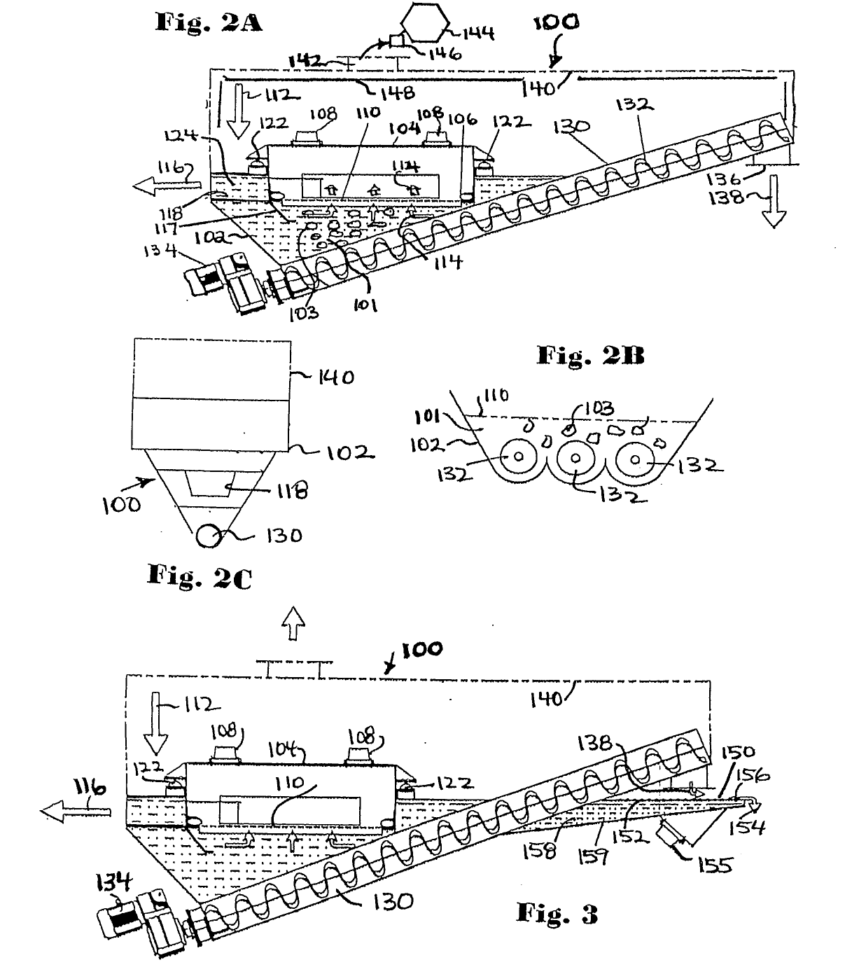

FIGS. 2A-2C illustrate a system 100 according to the present invention which has a housing 102 for containing material 101 to be treated. A screen apparatus 110 is removably secured to a box 104 which is mounted to the housing 102. Any known structure and/or apparatus may be used to removably secure the screen apparatus 110 to the box 104 and, as shown, in one aspect, a known inflatable seal apparatus 106 is used for this purpose.

Vibratory apparatus 108 (electromagnetic vibrator apparatus or piezoelectric vibrator apparatus) connected to the box 104 vibrates the box 104 and thus the screen apparatus 110. Any suitable known vibratory apparatus may be used for the vibratory apparatus 108. Any suitable known screen or screens, screen assembly or screen assemblies may be used for the screen apparatus 110. The box 104 is mounted on anti-vibration mounts 122. Optionally, the apparatus 108 is connected directly to the screen apparatus 110.

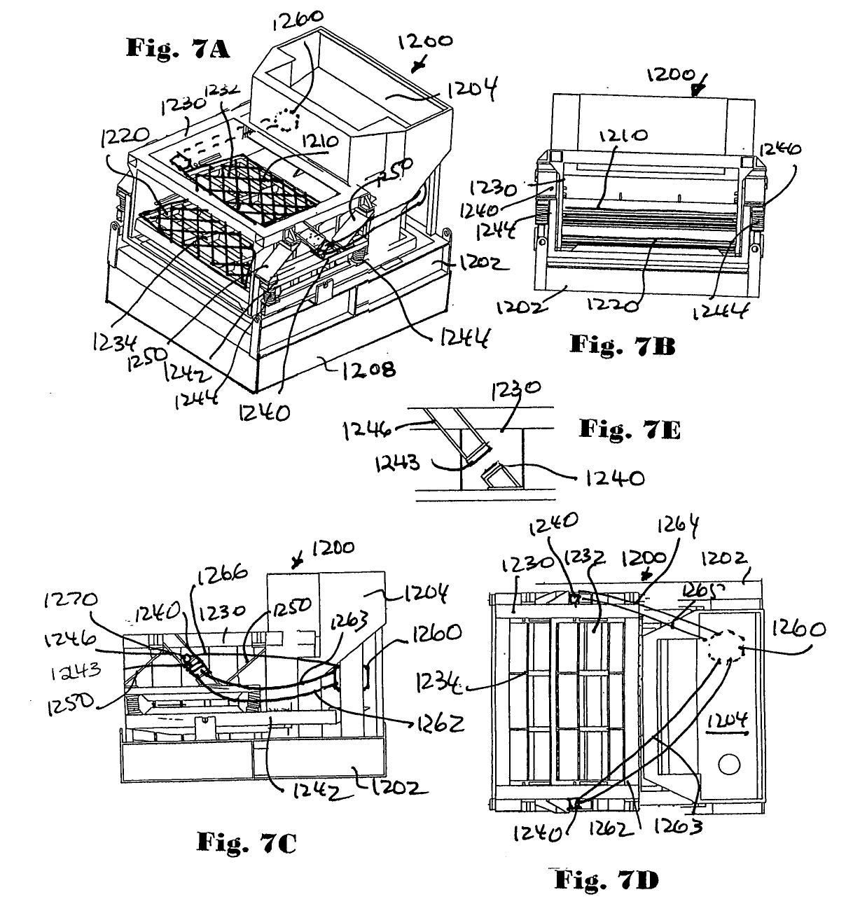

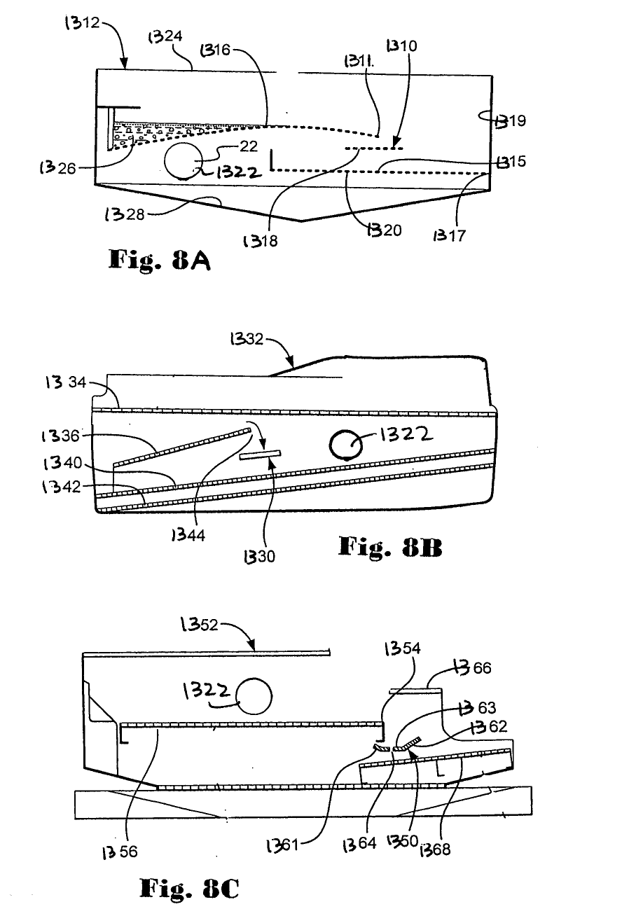

An arrow 112 indicates the introduction of the material 101 (including, but not limited to, drilling material including drilling fluid or mud, and drilled solids and debris) into the housing 102. Arrows 114 indicate the flow of the material 101 up to and, at least part thereof, through the screen apparatus 110. An arrow 116 indicates the discharge of recovered material, e.g. fluid and/or fluid plus solids, 124 through a discharge duct 118 from the box 104 (shown schematically in FIG. 7C). In one aspect the duct 118 is flexible or has a flexible portion so that the duct 118 and the box 104 can be lowered in the housing 102, e.g. for access, maintenance, or cleaning. A deflector 117 directs incoming fluid flow. Heavier and/or agglomerated solids, directed by the deflector 117, will flow downwardly to the conveyor system 130 and will not impact the screen apparatus 110.

Solids 103 that do not pass through the screen apparatus 110 fall within the housing 102 and enter a conveyor system 130. An auger apparatus 132 rotated by a motor 134 augers the solids S up to a discharge opening 136. An arrow 138 indicates the flow of the material with discharged solids from the system 100 to storage, to disposal, or to additional processing. In one aspect the auger, as shown, is inclined upwardly.

According to the present invention, one, two, three, four, or more auger apparatuses may be used with a system according to the present invention; e.g. the system 100 as shown in FIG. 7B has three auger apparatuses 132. Optionally, the system 100 is enclosed with an enclosure 140. In one aspect air, fumes, gases, and/or material entrained in air above the box 104 are evacuated through an access opening 142. Optionally this is accomplished by an HVAC system 144 and/or a filtration system 146 with appropriate pumping apparatus and/or vacuum apparatus. Optionally the enclosure 140 itself or the enclosure 140 with sound insulation material 148 reduces noise from the system 100.

FIG. 3 illustrates one embodiment of the system 100 (and like numerals indicate like parts) which includes a screen apparatus 150 which receives the discharged material 138. It is within the scope of the present invention for the screen apparatus 150 to be inclined downwardly and for material to move off of it under the influence of gravity; or, as shown, in FIG. 3 the screen apparatus 150 includes vibratory apparatus 155 (like, e.g. the vibratory apparatus 108) which vibrates a screen or screens 152 (e.g. like the screen apparatus 110). Separated solids 154 flow off an exit end 156 of the screen(s) 152 and reclaimed fluid 158 flows to a receptacle or container 159.

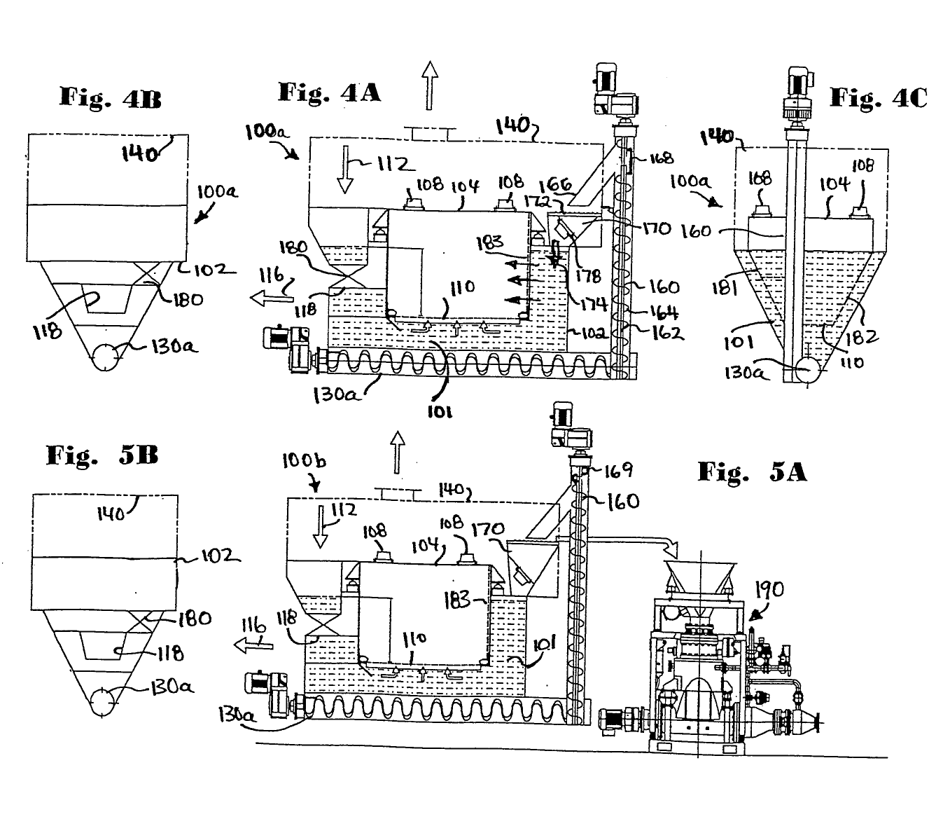

FIGS. 4A-4C illustrate an embodiment of a system 100 according to the present invention (like numerals indicate like parts) which includes at least one additional conveyor system 160 (like the conveyor system 130) which is oriented in a generally vertical orientation. A conveyor system 130a, like the system 130, may be oriented as shown in FIG. 2A or, as shown in FIG. 4A, may be oriented generally horizontally. The conveyor system 130a moves material with separated solids to the conveyor system 160 which, in turn, moves the material up to an exit duct 166. An optional paddle 168, secured to an auger apparatus 162 of the system 160 so that it is adjacent the duct 166, facilitates the movement of material into the exit duct 166. In one aspect the paddle 168 is a straight blade section on the auger apparatus 162 (as opposed to screw flights on the rest of the auger apparatus 162). Optionally, in one aspect a reversed flight 169 is used at the top of the auger apparatus (see, e.g. FIG. 5A) which moves material downwardly to the duct 166. Such a flight 169 can be used with the paddle 168.

Material with separated solids may, according to the present invention, flow to storage or to further processing or, as shown in FIG. 4A, may be introduced to a vibratory separator apparatus 170 with screening apparatus 172 (like the screening apparatus 110) vibrated by vibratory apparatus 178 (like the vibratory apparatus 108). It is within the scope of the present invention for the material with solids separated by the vibratory separator apparatus to flow to disposal, to storage, or to further processing. Reclaimed fluid from the vibratory separator apparatus 170 can be directed to storage or to a container; or, as shown in FIG. 4A by an arrow 174, it can flow back into the housing 102.

Optionally, a valve 180 selectively controls the flow of fluid into the housing 102. Optionally, in addition to (or instead of) the screen apparatus 110, one or more walls of the box 104 may have a screen mounted therein or thereon, or a screen or screens can be secured to the box 104. For example, as shown in FIG. 4C two inclined screens 181, 182 (like the screen apparatus 110) are secured to the box 104 and material 101 is flowable through the screens 181, 182 and through the screen apparatus 110. Additionally, and/or optionally, a further screen 183, oriented generally vertically, may be secured to a vertical face 184 of the box 104.

In certain aspects, the use of an additional conveyor, such as the conveyor system 160, makes it possible for the material depth within the housing 102 to be increased as compared to a system with a lower conveyor system or systems. This can permit a screen apparatus to be set relatively deeper in a box which can result in side screens being relatively taller so that more screening area is provided in a specified footprint area. In certain aspects according to the present invention, to empty a system as in FIG. 4A, a height adjustment is made for both the box 104 and the duct 118.

FIG. 5A illustrates a system 100b like the system 100a of FIG. 4A (like numerals indicate like parts) which includes a solids conveying system 190. Solids separated by the vibratory separator apparatus 170 are introduced to the solids conveying system 190. In one particular aspect the solids introduced to the system 190 are drilled cuttings separated from a material that includes drilling fluid and drilled solids (“drilled cuttings”) and the system 190 is a drilled cuttings conveyance system. It is within the scope of the present invention to employ any suitable known cuttings conveyance system for the system 190.

As shown in FIG. 6 a system 196 according to the present invention may have a plurality of vibratory separators 191, 192, 193 (as any according to the present invention; in one aspect, each vibratory separator is a shale shaker processing drilling material). Material to be processed flows in a feed conduit or “gutter” 195 and each separator or shaker 191-193 has a flow valve 180a, 180b, 180c, respectively which selectively controls flow to each separator or shaker 191-193. Thus one, two or three separators or shakers 191-193 can be operational as desired. It is within the scope of the present invention to provide one, two, three, four, five, six or more separators or shakers in a system 196 according to the present invention.

In certain of the claims that follow, “non-motorized vibrator apparatus” includes vibrators that are electromagnetic vibrators, or piezoelectric vibrators. Exemplary electromagnetic vibrator apparatuses are disclosed in U.S. Pat. Nos. 4,836,385; 6,543,620; 6,938,778; and 6,953,122; and exemplary piezoelectric vibrator apparatuses are disclosed in U.S. Pat. Nos. 6,543,620; 6,938,778; and 6,953,122—all of said patents incorporated fully herein.

FIGS. 7A-7E show a shale shaker 1200 according to the present invention which has a base 1202 with a fluid input tank 1204 from which drilling fluid with solids therein is fed to a screen assembly 1210. Drilling fluid passing through the screen assembly 1210 flows down and material (including undesirable solids such as drilled cuttings) moving up the screen assembly 1210 (which is inclined “uphill”) moves off the end of the screen assembly 1210 and flows down onto a lower screen assembly 1220 which is also inclined “uphill.” Drilling fluid passing through the screen assembly 1220 flows to a pit, tank or collection receptacle 1208 and material (including undesirable solids such as drilled cuttings) moves off the end of the screen assembly 1220 and falls to a container or further processing apparatus.

The screen assemblies 1210 and 1220 are releasably mounted to decks 1232, 1234 of a basket 1230. Two electromagnet apparatuses 1240 are mounted on a support 1242 which is, optionally, secured to the base 1202 with springs 1244. Plates 1243 secured to a mounting bracket 1246 (which, in one aspect, is made of composite material) which is secured to the basket 1230 are attracted by the electromagnetic apparatuses 1240. Each electromagnetic apparatus 1240 has a mounting bracket 1240a (which, in one aspect, is made of composite material) By pulsing power to the electromagnetic apparatuses 1240 (e.g. with alternating current), the plates are moved quickly toward and away from the electromagnetic apparatuses 1240, thus vibrating the basket 1230 and the screen assemblies 1210 and 1220.

An alternating current applied to the electromagnet causes an attractive electromagnetic force between the electromagnet and the plate. The frequency of input current to the electromagnet is same as the output vibration frequency of the basket. The vibration amplitude of the basket is a function of the input current and frequency to the electromagnet, weight of the basket and processed material, and the stiffness of the springs or resonators supporting the basket. Generally, as the input current to the electromagnet is increased, the vibration amplitude increases. As the input current to the electromagnet is decreased, the vibration amplitude decreases. In one aspect, the apparatuses 1240 vibrate the basket 1230 at its natural resonant frequency.

Leaf springs or resonators 1250 are interconnected between the basket 1230 and the support 1242 to allow the basket 1230 limited freedom of movement with respect to the electromagnetic apparatuses 1240.

A controller 1260 (shown schematically, which may be any suitable known programmable logic controller (“PLC”), variable frequency drive (“VFD”) (one for each apparatus 1240), or controller for controlling electromagnetic apparatuses and/or any controller or control system disclosed herein with suitable apparatus, devices, and programming for controlling the electromagnetic apparatuses) via lines 1262-1265 (shown schematically) controls the electromagnetic apparatuses 1240. In certain aspects the controller 1260 controls the frequency and amplitude of vibrations of the basket 1230 by controlling the electromagnetic apparatuses 1240. One or more accelerometers 1270 measure acceleration of the basket 1230 and provides signals via a cable 1266 (e.g. a multi-wire cable) to the controller 1260. In one aspect, the accelerometer measures acceleration and sends an output signal to a control system or PLC. The control system or PLC includes parameters to control the electromagnets. An acceleration setpoint is chosen and programmed into the PLC. If the accelerometer measures an acceleration below the setpoint, then the control system or PLC increases the input current to the electromagnets. If the accelerometer measures an acceleration above the setpoint, then the control system or PLC decreases the input current to the electromagnets. If the accelerometer measures an acceleration at the setpoint, then the control system or PLC maintains the previous input current to the electromagnets. Thus, the shaker can operate at constant acceleration under load (and under changing load) because of this closed-loop acceleration control, and, in one aspect, at a constant natural resonant frequency under load. Such a controller may be used to control any vibratory apparatus of any embodiment disclosed herein.

The system, in certain aspects, operates at the natural frequency of the basket with load springs or resonators. Operating the shaker at the system resonance greatly reduces the input energy required to drive the system. Certain traditional shakers can operate at many times the natural frequency and require excessive power to operate. Operating a shaker according to the present invention at its natural frequency reduces energy requirements and permits the use of lighter baskets.

Certain traditional shakers operate at a fixed motor speed and with a fixed rotating mass. This produces a fixed force at a fixed frequency. A basket without the additional mass of drilling mud operates at a nominal acceleration. As drilling mud is added to the basket, the system mass is increased, but the driving force remains fixed. This results in a significantly decreased acceleration. Acceleration is a primary factor determining shaker performance and fluid handling capacity. In order for a traditional shaker to be able to operate over a wide range of loads, some baskets have been designed to be exceptionally heavy compared to the load they process. This helps reduce the effect of decreasing acceleration with increasing load. However, heavy baskets operating above the system natural frequency require significant input power. Even with heavy baskets, some traditional shakers can lose up to 25% of their nominal acceleration with the addition of weighted drilling mud.

A shaker according to the present invention, in certain aspects, changes the input frequency to the electromagnets to match the natural frequency of the system. Thus, as more mass is added to the system with drilling mud, the PLC automatically determines the new lower natural frequency. In addition, in some aspects, the feedback from the accelerometer is used by the PLC to change the current to the electromagnet and maintain a constant acceleration amplitude. The electromagnets of the shaker can be driven with a typical input current function and a superimposed high-frequency signal to partially de-plug the screens. This can also be accomplished by out-of-phase driving with the typical input current functions. Since adding weight to the screens changes the system natural frequency, this frequency can be measured to assist in determining the weight of the cuttings discharged by the shaker. A signal representative of the natural frequency of the system is sent to the PLC and/or computer that calculates the total amount of solids discharged.

In one embodiment, the controller (PLC or computer) includes two control loops. One control loop controls the acceleration by varying the voltage supplied to the magnets and measuring the signal from the accelerometer, indicative of the acceleration. The other control loop controls the frequency to maintain the lowest ratio of input power to output acceleration. To find the natural frequency of the system, the controller sweeps the magnet frequency over a given range that the natural frequency is expected to lie within. The frequency that yields the greatest acceleration for the same input is the natural frequency. The frequency control loop tried to maintain the frequency at the natural frequency. Once the natural frequency is found, if the ratio of input power to output acceleration decreases, then the controller adjusts down the frequency until the frequency is found that minimizes the required input power to maintain the same acceleration. Any controller and/or control loop disclosed herein according to the present invention, and/ or driving apparatus, can be used with any separator or shaker disclosed herein according to the present invention.

It is within the scope of the present invention to provide a vibratory separator or shale shaker with one, two, or more electromagnetic vibrators, the vibratory separator or shaker having one, two or more generally horizontal screens and/or one, two, three or more screens inclined uphill.

FIG. 8A shows schematically a shale shaker 1312 according to the present invention with a flow diffusion apparatus 1310. The flow diffusion apparatus in FIG. 8A and those in FIG. 8B and FIG. 8C may be any flow diffusion apparatus disclosed in U.S. Pat. No. 6,868,972. Fluid flowing from an exit end 1311 of an upper screen 1316 hits the flow diffusion apparatus 1310. Without the flow diffusion apparatus 1310 in place, the fluid flowing from above would impact an area 1315 on a lower screen 1320. A basket 1324 supports the screens. The flow diffusion apparatus 1310 (as may be the case for any such apparatus) is secured to the basket 1324. The flow diffusion apparatus 1310 may be connected to the upper screen, the lower screen, or both in addition to, or instead of, securement to the basket 1324. The flow diffusion apparatus 1310 has one or a series of holes 1318 therethrough which permit fluid to flow therethrough down onto the lower screen 1320.

A vibratory apparatus 1322 (shown schematically; any electromagnetic vibratory apparatus disclosed herein) vibrates the basket 1324 in which the upper screen 1316 and lower screen 1320 are mounted. Fluid to be treated is introduced into a pool end 1326 of the shale shaker 1312. Fluid flows from both screens down into a collection receptacle 1328. Separated material exits from an exit end 1317 of the lower screen 1320.

FIG. 8B shows a shale shaker 1332 according to the present invention with a flow diffusion apparatus 1330. Fluid introduced at a fluid introduction end 1334 of the shale shaker 1332 flows to an upper screen 1336. The major portion of this fluid flows from the upper screen 1336 to an intermediate screen 1340 and through the intermediate screen 1340 to a lower screen 1342. Fluid flowing from an end 1344 of the intermediate screen 1340 (see arrow, FIG. 8B above the apparatus 1330) flows down onto the flow diffusion apparatus 1330 which, in the embodiment shown, is a solid plate; but which, according to the present invention, may have one or more holes, etc. for fluid flow therethrough. Vibrator apparatus 1322 (like that described above; shown schematically) vibrates a screen mounting basket 1346 in which the screens are located.

FIG. 8C shows a shale shaker 1352 according to the present invention which has a flow diffusion apparatus 1350 (like those described above) which is positioned below a fluid exit end 1354 of an upper screen 1356 (which, as may be any screen etc. of any embodiment herein, may be any suitable known screen(s), screen apparatus(es), or screen assembly or assemblies). Viewed on end the flow diffusion apparatus in one aspect has two sides 1361, 1362 spaced apart by a flat part 1363 in a truncated “V” shape, but it is within the scope of this invention for any flow diffusion apparatus herein to be “V” shaped, “U” shaped, truncated “V” or “U” shaped, or flat. In one aspect side 1361 and/or side 1362 is deleted.

Fluid flowing from the fluid exit end 1354 of the upper screen 1356 falls into the flow diffusion apparatus 1350 and moves from there down onto a lower screen 1368 (which, as may be any screen etc. of any embodiment herein, may be any suitable known screen(s), screen apparatus (es), or screen assembly or assemblies). In one aspect, fluid flow holes (of different diameters) are present in the flat part 1363 of the flow diffusion apparatus 1350. In one aspect, all of the holes are of the same diameter. In one aspect the flow diffusion apparatus 1350 extends under and corresponds in length to slightly less than the width of the upper screen 1356 above the flow diffusion apparatus 1350. Vibrator apparatus 1322 (shown schematically; like the apparatus 1322 described above) vibrates a screen mounting basket 1366 in which are secured the screens 1356 and 1368.

The present invention, therefore, provides in certain, but not necessarily all embodiments, a shale shaker having a base, a basket movably mounted on the base and for supporting screen apparatus for treating material including fluid introduced into the vibratory separator, screen apparatus supported by the basket, the material flowing to the screen apparatus for treatment, fluid flowing through the screen apparatus for collection, at least a portion of the screen apparatus not inclined downhill, electromagnetic vibratory apparatus connected to the basket for vibrating the basket and the screen apparatus, driving apparatus for driving the electromagnetic vibratory apparatus, and control apparatus for controlling the electromagnetic vibratory apparatus. In such a shaker the material can flow from below the screen apparatus up to the screen apparatus.

The present invention, therefore, provides in certain, but not necessarily all embodiments, a vibratory separator having a base, a basket movably mounted on the base and for supporting screen apparatus for treating material introduced to the vibratory separator, screen apparatus supported by the basket, the material flowing to the screen apparatus for treatment, at least a portion of the screen apparatus not inclined downhill, electromagnetic vibratory apparatus connected to the basket for vibrating the basket and the screen apparatus, driving apparatus for driving the electromagnetic vibratory apparatus, and control apparatus for controlling the driving apparatus and the electromagnetic vibratory apparatus. Such a shaker may include one or some, in any possible combination, of the following: wherein the material flows from below the screen apparatus up to the screen apparatus; or wherein all or at least a portion of the screen apparatus is inclined uphill; wherein all or at least a portion of the screen apparatus is horizontal; the screen apparatus having at least one upper screen apparatus in the basket, the at least one upper screen apparatus having a fluid exit end, and at least one lower screen apparatus in the basket below the at least one upper screen apparatus, fluid flowable from the at least one upper screen apparatus down onto the at least one lower screen apparatus, and flow diffusion apparatus mounted below the fluid exit end of the at least one upper screen apparatus and above the at least one lower screen apparatus, so that fluid flowing down from the at least one upper screen apparatus flows onto the flow diffusion apparatus and is diffused thereby; wherein the material is drilling fluid with drilled cuttings therein; wherein the electromagnetic vibratory apparatus includes a metal plate spaced-apart from an electromagnet; the driving apparatus having variable frequency drive apparatus for selectively driving the electromagnetic vibratory apparatus at a selected frequency, sensor apparatus connected to the vibratory separator for sensing a parameter indicative of operation of the vibratory separator for providing a signal corresponding to said parameter, and the control apparatus for receiving signals from the sensor apparatus, for controlling the vibratory separator based on said signals; flow sensor apparatus connected to the vibratory separator for sensing the flow of material to the screen apparatus, the flow sensor apparatus controlled by and in communication with the control apparatus, and the control apparatus for adjusting shaker operation in response to signals from the flow sensor apparatus; and/or wherein the control apparatus can automatically shut down the vibratory separator based on a parameter of the material or based on the flow rate of the material.

The present invention, therefore, provides in certain, but not necessarily all embodiments, an upflow vibratory separator having a box, a primary screen assembly in the box, a container, the box and the primary screen assembly in the container, vibratory apparatus for vibrating the primary screen assembly, at least part of the container disposed beneath the primary screen assembly, the vibratory apparatus being electromagnetic or piezoelectric vibratory apparatus, driving apparatus for driving the vibratory apparatus, and control apparatus for controlling the vibratory apparatus. Such an upflow vibratory separator may include one or some, in any possible combination, of the following: a primary conveyor beneath the primary screen assembly for removing solids that do not pass through the primary screen assembly; a material input for introducing the material into the container; a deflector adjacent the material input for directing material flowing through the material input away from the primary screen assembly; wherein the solids include liquid, the upflow vibratory separator further having separation apparatus for receiving solids conveyed by the primary conveyor, the separating apparatus for separating liquid from the solids; wherein the separation apparatus includes a secondary screen assembly for separating the solids from the liquid, the liquid flowing down through the secondary screen assembly; vibration apparatus (any disclosed herein) for vibrating the secondary screen assembly; wherein the material is drilling material including drilling fluid and drilled solids; a secondary container for receiving and containing fumes from the material; evacuation apparatus (which can be on any separator or shaker disclosed herein) for removing the fumes from the secondary container; filtration apparatus (which can be on any separator or shaker disclosed herein) for filtering the fumes from the secondary container; the primary screen assembly mounted generally horizontally, and at least one tertiary screen assembly mounted non-horizontally for treating the material; wherein the at least one tertiary screen assembly is two spaced-apart tertiary screen assemblies, each extending upwardly from the primary screen assembly; a valve for controlling flow of material into the container; a secondary conveyor for receiving the solids conveyed by the primary conveyor and for conveying the solids away from the primary conveyor, the solids including liquid; wherein the secondary conveyor has an exit through which solids including liquid exit for further processing; the secondary conveyor including auger apparatus for moving the solids including liquid to the exit; a paddle on the auger apparatus for moving solids including liquid to the exit; secondary vibratory separator apparatus for receiving solids including liquid from the exit of the secondary conveyor and for treating the solids including liquid, the secondary vibratory separator apparatus for producing separated solids and for producing liquid for introduction back into the container; solids conveying apparatus (e.g., but not limited to, any suitable known cuttings conveyance system) for receiving the solids from the secondary vibratory separator apparatus and for conveying the solids away from the upflow vibratory separator; and/or the primary conveyor including a plurality of spaced-apart auger apparatuses for moving the solids away from the upflow vibratory separator.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112.

What is claimed is:

1. A shale shaker comprising
a base,
a basket movably mounted on the base and for supporting screen apparatus for treating material including fluid introduced into the vibratory separator,
screen apparatus supported by the basket, the material flowing to the screen apparatus for treatment, fluid flowing through the screen apparatus for collection, at least a portion of the screen apparatus not inclined downhill,
electromagnetic vibratory apparatus connected to the basket for vibrating the basket and the screen apparatus,
driving apparatus for driving the electromagnetic vibratory apparatus, and
control apparatus for controlling the electromagnetic vibratory apparatus.

2. The shale shaker of claim 1 wherein the material flows from below the screen apparatus up to the screen apparatus.

3. A vibratory separator comprising
a base,
a basket movably mounted on the base and for supporting screen apparatus for treating material introduced to the vibratory separator,
screen apparatus supported by the basket, the material flowing to the screen apparatus for treatment, at least a portion of the screen apparatus not inclined downhill,
electromagnetic vibratory apparatus connected to the basket for vibrating the basket and the screen apparatus,
driving apparatus for driving the electromagnetic vibratory apparatus, and
control apparatus for controlling the driving apparatus and the electromagnetic vibratory apparatus.

4. The shale shaker of claim 3 wherein the material flows from below the screen apparatus up to the screen apparatus.

5. The vibratory separator of claim 3 wherein at least a portion of the screen apparatus is inclined uphill.

6. The vibratory separator of claim 3 wherein at least a portion of the screen apparatus is horizontal.

7. The vibratory separator of claim 3 further comprising
the screen apparatus comprising at least one upper screen apparatus in the basket, the at least one upper screen apparatus having a fluid exit end, and at least one lower screen apparatus in the basket below the at least one upper screen apparatus,
fluid flowable from the at least one upper screen apparatus down onto the at least one lower screen apparatus, and
flow diffusion apparatus mounted below the fluid exit end of the at least one upper screen apparatus and above the at least one lower screen apparatus, so that fluid flowing down from the at least one upper screen apparatus flows onto the flow diffusion apparatus and is diffused thereby.

8. The vibratory separator of claim 3 wherein the material is drilling fluid with drilled cuttings therein.

9. The vibratory separator of claim 7 wherein the electromagnetic vibratory apparatus includes a metal plate spaced-apart from an electromagnet.

10. The vibratory separator of claim 3 further comprising
the driving apparatus comprising variable frequency drive apparatus for selectively driving the electromagnetic vibratory apparatus at a selected frequency,
sensor apparatus connected to the vibratory separator for sensing a parameter indicative of operation of the vibratory separator for providing a signal corresponding to said parameter, and
the control apparatus for receiving signals from the sensor apparatus, for controlling the vibratory separator based on said signals.

11. The vibratory separator of claim 3 further comprising
flow sensor apparatus connected to the vibratory separator for sensing the flow of material to the screen apparatus,
the flow sensor apparatus controlled by and in communication with the control apparatus, and
the control apparatus for adjusting shaker operation in response to signals from the flow sensor apparatus.

12. The vibratory separator of claim 3 wherein the control apparatus can automatically shut down the vibratory separator based on a parameter of the material or based on the flow rate of the material.

13. An upflow vibratory separator comprising
a box,
a primary screen assembly in the box,
a container, the box and the primary screen assembly in the container,
vibratory apparatus for vibrating the primary screen assembly,
at least part of the container disposed beneath the primary screen assembly,
the vibratory apparatus comprising electromagnetic vibratory apparatus,
driving apparatus for driving the electromagnetic vibratory apparatus, and
control apparatus for controlling the electromagnetic vibratory apparatus.

14. The upflow vibratory separator of claim 13 further comprising
a primary conveyor beneath the primary screen assembly for removing solids that do not pass through the primary screen assembly.

15. The upflow vibratory separator of claim 13 further comprising
a material input for introducing the material into the container,
a deflector adjacent the material input for directing material flowing through the material input away from the primary screen assembly.

16. The upflow vibratory separator of claim 13 wherein the solids include liquid, the upflow vibratory separator further comprising
separation apparatus for receiving solids conveyed by the primary conveyor, the separating apparatus for separating liquid from the solids.

17. The upflow vibratory separator of claim 16 wherein the separation apparatus includes a secondary screen assembly for separating the solids from the liquid, the liquid flowing down through the secondary screen assembly.

18. The upflow vibratory separator of claim 17 further comprising
vibration apparatus for vibrating the secondary screen assembly.

19. The upflow vibratory separator of claim 13 wherein the material is drilling material including drilling fluid and drilled solids.

20. The upflow vibratory separator of claim 13 further comprising
a secondary container for receiving and containing fumes from the material.

21. The upflow vibratory separator of claim 20 further comprising
evacuation apparatus for removing the fumes from the secondary container.

22. The upflow vibratory separator of claim 21 further comprising
filtration apparatus for filtering the fumes from the secondary container.

23. The upflow vibratory separator of claim 13 further comprising
the primary screen assembly mounted generally horizontally, and
at least one tertiary screen assembly mounted non-horizontally for treating the material.

24. The upflow vibratory separator of claim 23 wherein the at least one tertiary screen assembly is two spaced-apart tertiary screen assemblies, each extending upwardly from the primary screen assembly.

25. The upflow vibratory separator of claim 13 further comprising
a valve for controlling flow of material into the container.

26. The upflow vibratory separator of claim 13 further comprising
a secondary conveyor for receiving the solids conveyed by the primary conveyor and for conveying the solids away from the primary conveyor, the solids including liquid.

27. The upflow vibratory separator of claim 26 wherein the secondary conveyor has an exit through which solids including liquid exit for further processing.

28. The upflow vibratory separator of claim 27 further comprising
the secondary conveyor including auger apparatus for moving the solids including liquid to the exit.

29. The upflow vibratory separator of claim 28 further comprising
a paddle on the auger apparatus for moving solids including liquid to the exit.

30. The upflow vibratory separator of claim 27 further comprising
secondary vibratory separator apparatus for receiving solids including liquid from the exit of the secondary conveyor and for treating the solids including liquid, the secondary vibratory separator apparatus for producing separated solids and for producing liquid for introduction back into the container.

31. The upflow vibratory separator of claim 30 further comprising
solids conveying apparatus for receiving the solids from the secondary vibratory separator apparatus and for conveying the solids away from the upflow vibratory separator.

32. The upflow vibratory separator of claim 28 further comprising
the primary conveyor including a plurality of spaced-apart auger apparatuses for moving the solids away from the upflow vibratory separator.

33. An upflow vibratory separator comprising
a box,
a primary screen assembly in the box,
a container, the box and the primary screen assembly in the container,
vibratory apparatus for vibrating the primary screen assembly,
at least part of the container disposed beneath the primary screen assembly,
the vibratory apparatus comprising piezoelectric vibratory apparatus,
driving apparatus for driving the piezoelectric vibratory apparatus, and
control apparatus for controlling the piezoelectric vibratory apparatus.
